(19) United States
(12) Patent Application Publication
(10) Pub. No.: US 2009/0025008 A1
(43) Pub. Date: Jan. 22, 2009

(54) IPMI SYSTEMS AND ELECTRONIC APPARATUS USING THE SAME

(75) Inventor: Shang-Ching Hung, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei (TW)

(21) Appl. No.: 11/779,955

(22) Filed: Jul. 19, 2007

(51) Int. Cl. G06F 9/44; G06F 12/02

(52) U.S. Cl. 719/312; 711/170; 711/E12.084

(57) ABSTRACT

Intelligent Platform Management Interface (IPMI) systems are disclosed, in which a baseboard management controller (BMC) is coupled to a first memory device and a server system, such that the BMC accesses the first memory device to provide a first set of functions and accesses a second memory device from the server system to provide a second set of functions.

### BACKGROUND OF THE INVENTION

1. Field of the Invention

The invention relates to a server system, and in particular to server systems with an intelligent platform management interface (IPMI).

2. Description of the Related Art

Due to the frequency of failures occurring in server systems such as telecommunications equipments, computer stations or host systems, it is important that the server administrator has a mechanism for monitoring the operational status of the server system, to ensure that the server system is functioning properly. One conventional way of monitoring a server system is by status information request using a standard input device (i.e., a mouse and a keyboard) and by viewing the status information on a display directly coupled to the server system.

When server systems are non-operational, an administrator must go to the server system's location to fix the problem. This requires a lot of manpower and time. It is very inconvenient for management. To solve this issue, intelligent platform management interface (IPMI), has been developed to manage server systems. Generally, the IPMI monitors characteristics of the server system, such as temperature, voltage, power supplies and fan speed, while operating independently from the server system's OS (Operating System). Namely, IPIM cam operates system management in the absence of the OS or system management software, or the server system not being powered on.

### BRIEF SUMMARY OF THE INVENTION

A detailed description is given in the following embodiments with reference to the accompanying drawings.

Embodiments of an Intelligent Platform Management Interface (IPMI) system are provided, in which a first memory device is provided, and a baseboard management controller (BMC) is coupled to the first memory device and a server system, such that the BMC accesses the first memory device to provide a first set of functions and accesses a second memory device from the server system to provide a second set of functions.

The invention provides another embodiment of an electronic apparatus, in which a server system and an Intelligent Platform Management Interface (IPMI) system monitoring status information of the server system. The IPMI system comprises a first memory device, and a baseboard management controller (BMC) coupled to the first memory device, such that the BMC accesses the first memory device to provide a first set of functions and accesses a second memory device from the server system to provide a second set of function.

The invention provides an embodiment of a memory sharing of an IPMI system method, wherein the IPMI system comprising a baseboard management controller (BMC) and a first memory device is connected to a server system. A second memory device is allocated to the IPMI system, such that the BMC accesses the first memory device to provide a first set of functions and accesses the second memory device from the server system to provide a second set of functions.

### BRIEF DESCRIPTION OF THE DRAWINGS

The invention can be more fully understood by reading the subsequent detailed description and examples with references made to the accompanying drawings, wherein:

FIG. 1 shows an embodiment of an electronic apparatus in the invention;

FIG. 2 shows another embodiment of the electronic apparatus in the invention;

FIG. 3 shows another embodiment of the electronic apparatus in the invention;

FIG. 4 shows a flowchart of an embodiment of a memory sharing method in the invention; and

FIG. 5 shows a flowchart of another embodiment of a memory sharing method in the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

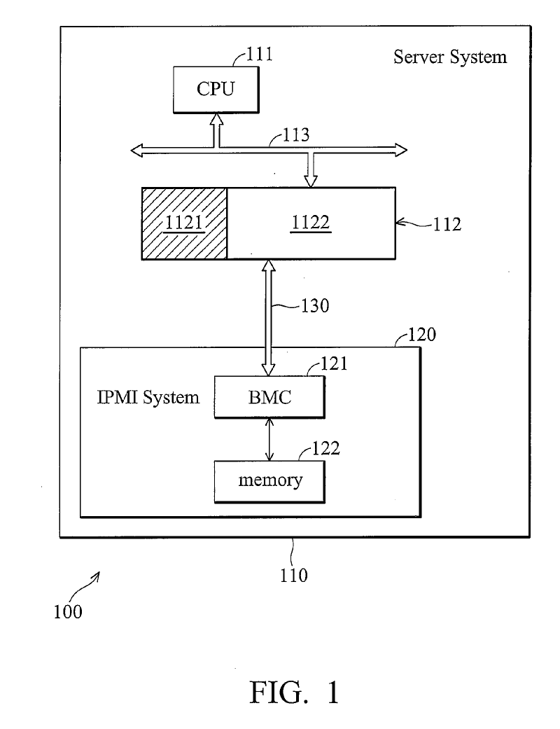

FIG. 1 shows an embodiment of an electronic apparatus in the invention. As shown, the electronic apparatus 100 comprises a server system 110 and an intelligent platform management interface (IPMI) system 120 for providing status information of the server system 110. The server system 100 can be any electronic system designed to perform computations and/or data processing. For example, the server system 110 can be a host system, a computer station or a telecommunication equipment, but is not limited thereto. The server system 110 comprises a printed circuit board, such as a motherboard or server board, having various components connected to the motherboard or mounted thereon. In the illustrated embodiment, the server system 110 comprises a central processing unit (CPU) 111, a system memory 112, a system bus 113, an access bus 130, a storage (not shown), a network interface (not shown), etc. For example, the CPU 111, the system memory 112, the system bus 113, the access bus 130 can be mounted on a motherboard (not shown), and the access bus 130 is connected between the system memory 112 and the IPMI system 120. The access bus 130 is dedicated for a BMC 121 of the IPMI system 120 to access a portion 1121 of the system memory 112. The server system 110 is configured to utilize an operating system, such as Microsoft Windows XP, Microsoft Windows Serial, Mac, UNIX, LINUX, etc., to manage hardware resources and to provide a platform for executing of software programs using the CPU 111.

In another embodiment, the server system 110 may further comprise a video driver to couple to a display device, such as a CRT (cathode ray tube) or LCD (liquid crystal display) monitor, and one or more input devices, such as a mouse and a keyboard. The display device and input devices can be utilized by an administrator to interact with the server system 110. The CPU 111 is the core element of the server system 110 for calculating and executing the specific functions provided by the system software, such as operating system (OS), to provide services to users. The system memory 112 can be divided into two portions 1121 and 1122, and the system memory 112 can, for example, be a 512 MB or 1 GB memory, but is not limited thereto.

The IPMI system 120 comprises a baseboard management controller (BMC) 121 and a memory 122, to monitor, maintain and recover characteristics of the server system 110, such as temperature, voltage, power supplies, fan speed, bus errors or system physical security, but is not limited thereto. The BMC 121 is coupled to the system memory 112 via the access bus 130, and the memory 122 stores status information about the server system 110. The memory 122 can be a non-volatile memory, e.g., an electrically erasable programmable read-only memory (EEPROM). The memory 122 can be a 4 MB or 8 MB memory, but is not limited thereto. Further, the IPMI system 120 operates independently from the operating system (OS) of the server system 110, i.e. the IPMI system 120 can operate system management in the absence of the operating system or system management software, or the server system 110 not being powered on.

For example, the IPMI system 120 can also comprise associated sensors that monitor the status of the server system 110 and outputs sensing results to the BMC 121. In another embodiment, the BMC 121 can also comprise a network interface, such as Internet Ethernet port, to connect to a data communications network and a display interface to couple with a display unit. The IPMI system 120 may further comprise a single printed circuit board (PCB) having various components mounted thereon. This PCB may be adapted to be mounted onto the motherboard or the chassis of the server system 110.

The IPMI system 120 may be powered by a power supply through its connection with the motherboard in the server system 110. Alternatively, the IPMI system 120 may have a direct connection to the power supply in the server system 110, or to an external power supply. The IPMI system 120 may further be provided a battery which can be used to power the IPMI system 120 in the event of a power failure.

In the embodiment, the portion 1121 of the system memory 112 is allocated to the BMC 121 when the server system 110 is installed a memory sharing driver to the operating system (OS). For example, when the memory sharing driver (not shown) is installed to the operating system of the server system 110 by users, the operating system allocates the portion 1121 of the system memory 112 in the server system 110 to the IPMI system 120, such that the BMC 121 of the IPMI system 120 can access the memory 122 to provide a first set of functions and can access the portion 1121 of the system memory 112 in the server system 110 to provide a second set of functions. When the portion 1121 of the system memory 112 is allocated to the IPMI system 120, the CPU 111 does not access the portion 1121 of the system memory 112. In one embodiment, the first set of functions may be IPMI basic functions, and the second set of functions may be OEM advanced functions.

Generally, memory capacity of an electronic system relates to the functions which the electronic system can provide. For example, when the memory capacity of the electronic system is large, the electronic system can provide more and advanced functions. On the contrary, when the memory capacity of the electronic system is small, the electronic system can only provide lesser and more basic functions. Hence, functions provided by the electronic system are limited by the memory capacity of the electronic system.

In the embodiment, the portion 1121 of the system memory 112 in the server system 110 is shared with the IPMI system 120 by the memory sharing driver and the portion 1121 of the system memory 112 has memory capacity larger than that of the memory 122. For example, the portion 1211 of the system memory 112 can be identical to or much larger than that of the memory 122, but is not limited thereto. Thus, the IPMI system 120 can access the memory 122 to provide basic functions serving as the first set of functions and access portion 1121 of the system memory 112 in the server system 110 to provide more, advanced and powerful functions serving as the second set of the functions. For example, the first set of functions can be the basic functions defined by the IPMI specification and executed when the BMC 121 can access the memory 122 without the portion 1121 of the system memory 112. The second set of functions can be functions executed when the BMC 121 can access the portion 1121 of the system memory 112 or both the memory 122 and the portion 1121 of the system memory 112.

In addition, the IPMI system 120 periodically checks whether the portion 1121 of the system memory 112 is still accessible. If so, the BMC 121 continues providing both the first set of functions (i.e., basic functions) and the second set of functions (i.e., advanced functions). If the BMC 121 in the IPMI system 120 cannot access the system memory 112, the IPMI system 120 stops supporting the second set of functions (i.e. the BMC 121 provides the first set of functions only). For example, the BMC 121 stops providing the advanced functions when the memory sharing driver is removed (uninstalled) from the operating system in the server system 110 by users, the system memory 112 is removed from the server system 110, the server system 110 is powered off or the system memory 112 fails, etc. Further, when the memory sharing driver is removed from the operating system in the server system 110, the portion 1121 of the system memory 112 is not allocated to the IPMI system 112, and thus, the CPU 111 accesses both portions 1121 and 1122 of the system memory 112 again for computation or storing.

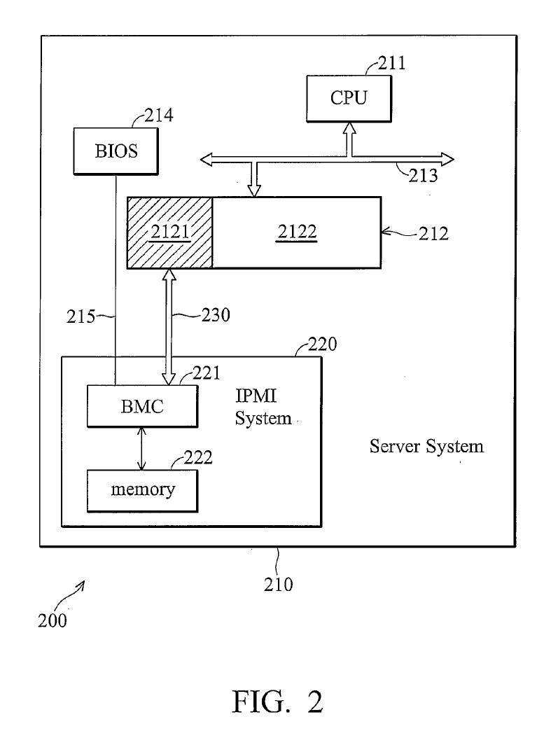

FIG. 2 shows another embodiment of the electronic apparatus in the invention. As shown, the electronic apparatus 200 is similar to the electronic apparatus 100 shown in FIG. 1, differing only in that a basic input/output system (BIOS) 214 in the server system 210 is coupled to the BMC 221 in the IPMI system 220 by a memory access control pin 215. Operations and structure of the CPU 211, the system memory 212, the system bus 213, the BMC 221 and the memory 222 are similar to that shown in FIG. 1, and thus are omitted for simplification.

In this embodiment, the portion 2121 of the system memory 212 is allocated to the BMC 221 when the server system 210 executes the BIOS 214. For example, the BIOS 214 comprises a field (item) setting with whether memory sharing for the IPMI system 220 is supported and another field setting with the sharing capacity of the system memory 212 (i.e., the capacity of the portion 2121). If the BIOS 214 supports the sharing memory, it detects whether the IPMI system 220 exists when the BIOS 214 is booted. If the IPMI system 220 exists, the BIOS 214 allocates the portion 2121 of the system memory 212 to the IPMI system 220 via the memory access control pin 215, such that the BMC 221 of the IPMI system 220 can access the memory 222 to provide a first set of functions and further access the portion 2121 of the system memory 212 in the server system 210 to provide a second set of functions.

In addition, if the second set of functions is not required, the server system 220 should be rebooted to modify the BIOS 214 by users, such that BIOS 214 does not allocate the portion 2121 of the system memory 212 to the IPMI system 220. Further, when the BMC 221 cannot access the portion 2121 of the system memory 212 in the server system 210, the BMC 221 provides the first set of functions (i.e., basic functions) without the second set of functions (i.e., advanced functions). For example, the BMC 221 stops providing the advanced functions when the BIOS 214 is not set to allocate the portion 2121 of the system memory 212 to the IPMI system 220, the system memory 212 is removed from the server system 210, the server system 210 is powered off or the system memory 212 fails, etc.

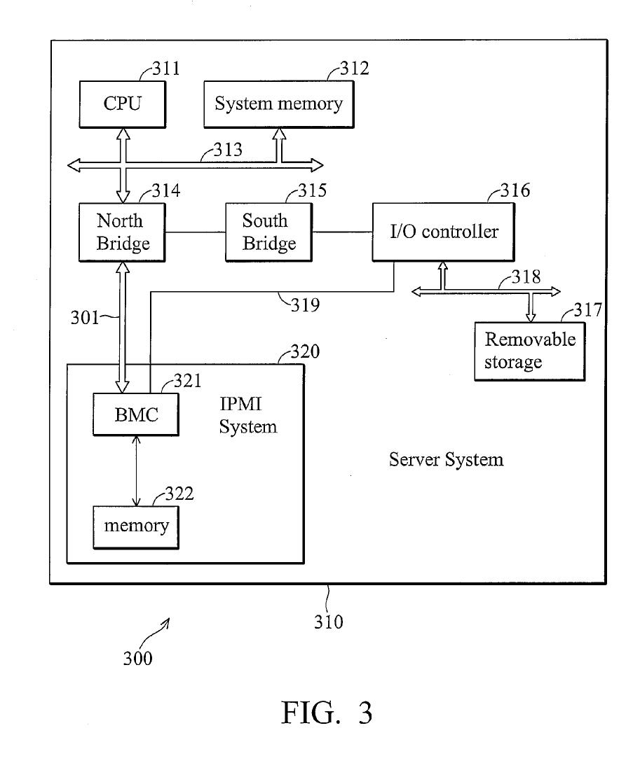

FIG. 3 shows another embodiment of the electronic apparatus in the invention. As shown, the server system 310 comprises a central processing unit (CPU) 311, a system memory 312, a system bus 313, an input/output (I/O) controller 316, a removable storage 317, an I/O bus 318, a low pin count (LPC) interface 319, and an access bus 301. The system bus 313 is coupled between the CPU 311, the system memory 312 and the north bridge 314. The I/O bus 318 is coupled between the I/O controller 316, the removable storage 317, a display device (not shown), and input devices, e.g. a keyboard, a mouse, a floppy disk drive, etc. For example, the CPU 311, the system memory 312, the system bus 313, the I/O controller 316, the removable storage 317, the I/O bus 318, the LPC interface 319 and the access bus 301 can be mounted on a motherboard (not shown), in which the BMC 321 in the IPMI system 320 is coupled to the north bridge 314 via the access bus 301 and to the I/O controller 316 via the LPC interface 319. The north bridge 314 and the south bridge 315 can be separate chips or an integrated single chip. Operations of the similar components in electronic apparatuses 300 and 100 can be referenced in FIG. 1 and thus, are omitted for simplification.

The access bus 301 is dedicated for the IPMI system 320 to communicate with the north bridge 314, and the LPC interface 319 is dedicated for the IPMI system 320 to access the removable storage 317 via the I/O controller 316 and the I/O bus 318. In the embodiment, the removable storage 317 can be a non-volatile memory, e.g., an electrically erasable programmable read-only memory (EEPROM), a flash memory or hard disk drive, but is not limited thereto. In addition, capacity of the removable storage 317 can be identical to or much larger than that of the memory 322 in the IPMI system 320.

The IPMI system 320 comprises a baseboard management controller (BMC) 321 and a memory 322 coupled to the BMC 321, to monitor, maintain and recover characteristics of the server system 310, such as temperature, voltage, power supplies, fan speed, bus errors or the systems physical security, but is not limited thereto. In the embodiment, the BMC 321 is further coupled to the north bridge 314 and the I/O controller 316 in the server system 310 via the access bus 301 and the LPC interface 319, respectively.

In the embodiment, the BMC 321 in the IPMI system 320 can assess the removable storage 317 by communicating with the north bridge 314. For example, when a memory sharing driver (not shown) is installed to the operating system of the server system 310 by users, the BMC 321 can communicate with the north bridge 314 and access the removable storage 317 via the I/O controller 316. In another embodiment, after the BMC 321 asserts a request to the north bridge 314 to access the removable storage 317, the north bridge 314 outputs inductions to the I/O controller 316, such that the BMC 321 can access the removable storage 317 via the I/O controller 316. Hence, the BMC 321 of the IPMI system 320 can access the memory 322 to provide a first set of functions (i.e., basic functions) and further access the removable storage 317 in the server system 110 to provide a second set of functions (i.e., advanced functions).

In addition, when the BMC 321 cannot access removable storage 317 in the server system 310, the BMC 321 provides the first set of functions without the second set of functions. For example, the BMC 321 stops providing the advanced functions when the memory sharing driver is removed (uninstalled) from the operating system in the server system 310 by users, the removable storage 317 is removed from the server system 310, the server system 310 is powered off or the removable storage 317 fails, etc.

Because the IPMI system in the embodiments can access the system memory or removable storage in the server system, its usable memory capacity is enlarged, and thus it can provide more and advanced functions or services.

The invention also provides a memory sharing method to overcome limitation of memory capacity, whereby the electronic apparatus shares a memory space from the host computer and the IPMI system, such that the IPMI system can utilize a larger memory to provide more and advanced functions or services. For example, the shared memory can be allocated to the IPMI system by executing BIOS, installing a memory sharing driver to the operating system in the server system, or communicating with the north bride in the server system.

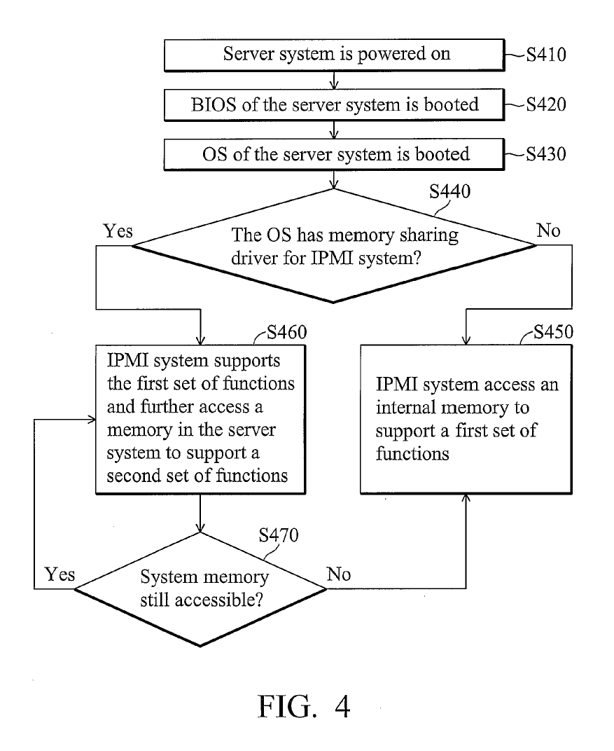

FIG. 4 shows a flowchart of an embodiment of a memory sharing method in the invention. The embodiment of the memory sharing method comprises steps S410-S470 and is described hereinafter with reference to FIG. 1. In step S410, the server system 110 is powered on. In step S420, the BIOS of the server system 110 is booted. In step S430, OS of the server system 110 is booted. In step S440, the OS of the server system 110 detects whether a memory sharing driver for the IPMI system 120 exists. The memory sharing driver is used to allocate a memory space in the server system 110 to the IPMI system 120. If the OS detects that there is no memory sharing driver for the IPMI system 120, step S450 is then executed. If the OS detects that the memory sharing driver for the IPMI system 120 exists (i.e., the memory sharing driver for the IPMI system 120 is installed), step S460 is then executed.

In step S450, the OS in server system 110 does not allocate any assessable memory space to the IPMI system 120, such that the BMC 121 in the IPMI system 120 accesses the memory 122 without the portion 1121 of the system memory 112 to provide a first set of functions. For example, the first set of functions can be the basic functions defined by the IPMI specification and executed when the BMC 121 accesses the memory 122 without the memory space in the server system 110. In another example, with no memory sharing driver (i.e., step S450), the IPMI system 120 can detect whether the OS is accessible. If the OS is not assessable, the IPMI system 120 keeps providing the first set of functions. If the OS is accessible, the IPMI system 120 outputs a signal to the server system 110, such that the OS inquires users whether there is a need to install the memory sharing driver, and then the method goes back to the step S440.

In step S460, the operating system allocates the portion 1121 of the system memory 212 in the server system 110 to the IPMI system 120, such that the BMC 121 of the IPMI system 120 can access the memory 122 to provide a first set of functions and can access the portion 1121 of the system memory 112 in the server system 110 to provide a second set of functions.

Generally, memory capacity of an electronic system relates to the functions which the electronic system can provide. For example, when the memory capacity of the electronic system is large, the electronic system can provide more and advanced functions. On the contrary, when the memory capacity of the electronic system is small, the electronic system can only provide lesser and more basic functions. Hence, functions provided by the electronic system are limited by the memory capacity of the electronic system. Because the capacity of the portion 1211 of the system memory 112 can be identical to or much larger than that of the memory 122 in the IPMI system 120, the IPMI system 120 can access the portion 1121 of the system memory 112 in the server system 110 to provide more, advanced and powerful functions serving as the second set of the functions. For example, the second set of functions can be functions executed when the BMC 121 can access the portion 1121 of the system memory 112 or both the memory 122 and the portion 1121 of the system memory 112.

In step S470, the IPMI system 120 periodically checks whether the portion 1121 of the system memory 112 is still accessible. If so, the BMC 121 continues providing the first set of functions (i.e., basic functions) and the second set of functions (i.e., advanced functions) in step S460. If the BMC 122 in the IPMI system 120 cannot access the system memory 112, the IPMI system 120 stops supporting the second set of functions, (i.e. the BMC 121 provides the first set of functions without the second set of functions), and the method goes to the step S450. For example, the BMC 121 stops providing the advanced functions when the memory sharing driver is removed (uninstalled) from the operating system in the server system 110 by users, the system memory 112 is removed from the server system 110, the server system 110 is powered off or the system memory 112 fails, etc.

In another embodiment, operating system (IPMI OS) in the IPMI system 120 detects whether a memory space in the server system 110 is allocated for the IPMI system 120. If so, the IPMI OS loads the related firmware, such that the IPMI system 120 can communicate with the shared memory space in the server system 110 and provide more and advanced functions and services (i.e., the second set of functions). If not, the IPMI system 120 only provides the first set of functions (i.e., basic functions defined by the IPMI specification).

Alternatively, as shown in FIG. 3, the memory sharing driver can be installed to the OS of the server system 310, thereby establishing a communication between server system 310 and the BMC 321 in the IPMI system 320. Hence, the BMC 321 in the IPMI system 320 can access the removable storage 317 of the server system 310 via the I/O controller 315 by communicating with the north bridge 319 to provide the second set of functions. For example, when the BMC 321 asserts a request to the north bridge 314 to access the removable storage 317, the north bridge 314 then outputs inductions to the I/O controller 316, such that the BMC 321 can access the removable storage 317 via the I/O controller 316. Thus, the BMC 321 of the IPMI system 320 can access the memory 322 to provide a first set of functions and can access the removable storage 317 in the server system 310 to provide a second set of functions.

Similarly as previous, when the BMC 321 cannot access removable storage 317 in the server system 310, the BMC 321 provides the first set of functions (i.e., basic functions) without the second set of functions (i.e., advanced functions). For example, the BMC 121 stops providing the advanced functions when the memory sharing driver is removed (uninstalled) from the operating system in the server system 310 by users, the removable storage 317 is removed from the server system 310, the server system 310 is powered off or the removable storage 317 fails, etc.

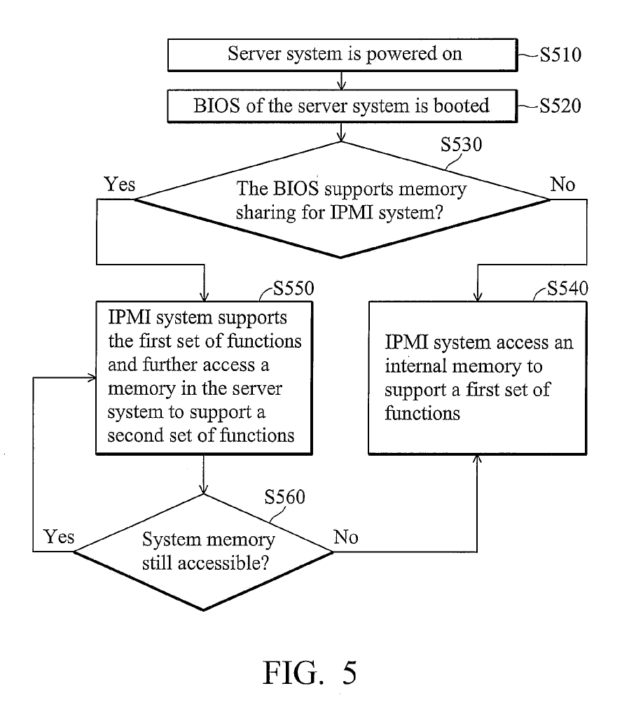

FIG. 5 shows a flowchart of another embodiment of a memory sharing method in the invention. The embodiment of the memory sharing method comprises steps S510-S560 and would be described hereinafter with reference to FIG. 2.

In step S510, the server system 210 is powered on. In step S520, BIOS 214 of the server system 210 is booted. In step S530, the BIOS 214 detects whether a memory sharing for the IPMI system 220 is supported. If the BIOS 214 supports the memory sharing, step S540 is then executed. If the BIOS 214 does support the memory sharing, the step S550 is then executed. For example, the BIOS 214 comprises a field (item) setting with whether memory sharing for IPMI system 220 is supported and another field setting with the sharing capacity of the system memory 212 (i.e., the capacity of the portion 2121) by users. If the BIOS 214 supports memory sharing, it detects whether the IPMI system 220 exists when the BIOS 214 is booted. The BIOS 214 allocates the portion 2121 of the system memory 212 to the IPMI system 220 via the memory access control pin 215 if the IPMI system 220 exists.

In step S540, because the BIOS 214 does not support the memory sharing, the BIOS 214 does not allocate any memory space in server system 210 for the IPMI system 220. Hence, the BMC 221 in the IPMI system 220 accesses the memory 222 without the portion 2121 of the system memory 212 to provide a first set of functions. For example, the first set of functions can be the basic functions defined by the IPMI specification and executed when the BMC 221 accesses the memory 222 without the memory space in the server system 210.

In step S550, because the BIOS 214 supports the memory sharing, the BIOS 214 allocates the portion 2121 of the system memory 212 in the server system 210 to the IPMI system 220. Hence, the BMC 221 of the IPMI system 220 can access the memory 222 to provide a first set of functions and further access the portion 2121 of the system memory 212 in the server system 210 to provide a second set of functions. For example, the second set of functions can be functions executed when the BMC 221 can access the portion 2121 of the system memory 212 or both the memory 222 and the portion 2121 of the system memory 212.

In step S560, the IPMI system 220 periodically checks whether the portion 2121 of the system memory 212 is still accessible. If so, the BMC 221 continues providing the first set of functions (i.e., basic functions) and the second set of functions (i.e., advanced functions) in step S550. If the BMC 222 in the IPMI system 220 cannot access the system memory 212, the IPMI system 220 stops supporting the second set of functions, (i.e., the BMC 221 provides the first set of functions without the second set of functions), and the method goes to the step S540. For example, the BMC 221 stops providing the advanced functions when the system memory 212 is removed from the server system 210, the server system 210 is powered off or the system memory 212 fails, etc.

For example, the operating system (IPMI OS) in the IPMI system 220 detects whether a memory space in the server system 210 is allocated for the IPMI system 220, and if so, the IPMI OS loads the related firmware, such that the IPMI system 220 can communicate with the shared memory space in the server system 210 and provide more and advanced functions and services. If not, the IPMI system 220 provides the first set of functions (i.e., basic functions defined by the IPMI specification) only. In addition, if the second set of functions is not required, the server system 220 should be rebooted to set the BIOS 214 by users, such that BIOS 214 does not allocate the portion 2121 of the system memory 212 to the IPMI system 220. The IPMI system can use the internal memory/storage to execute the IPMI basic functions. The IPMI system can use the external memory/storage, rather than the internal memory/storage, to execute the OEM advanced functions. In one embodiment, the IPMI system can use the external memory/storage and the internal memory/storage to execute the OEM advanced functions.

Because the IPMI system in the embodiments can access the system memory or removable storage from the host computer in the server system, its usable memory capacity is enlarged, and thus it can provide more and advanced functions or services.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An Intelligent Platform Management Interface (IPMI) system, comprising:
a first memory device; and
a baseboard management controller (BMC) coupled to the first memory device and a server system, such that the BMC accesses the first memory device to provide a first set of functions and accesses a second memory device from the server system to provide a second set of functions.

2. The IPMI system of claim 1, wherein the second memory device is allocated to the BMC when the server system executes a basic input/output system (BIOS).

3. The IPMI system of claim 2, wherein the BMC is coupled to a memory access control pin of the basic input/output system (BIOS).

4. The IPMI system of claim 1, wherein the second memory device is a portion of a system memory in the server system.

5. The IPMI system of claim 1, wherein the second memory device is allocated to the BMC when the server system provides a memory sharing driver to an operating system in the server system.

6. The IPMI system of claim 5, wherein the BMC is further coupled to an input/output (I/O) controller and a bridge in the server system, such that the BMC accesses the second memory device in the server system by communicating with the bridge.

7. The IPMI system of claim 6, wherein the bridge comprising a north bridge chip.

8. The IPMI system of claim 6, wherein the second memory device is a removable storage.

9. The IPMI system of claim 1, wherein the BMC stops providing a second set of functions when the BMC cannot access the second memory device.

10. An electronic apparatus, comprising:
a server system; and
an Intelligent Platform Management Interface (IPMI) system monitoring status information of the server system and comprising:
a first memory device; and
a baseboard management controller (BMC) coupled to the first memory device, such that the BMC accesses the first memory device to provide a first set of functions and accesses a second memory device from the server system to provide a second set of functions.

11. The electronic apparatus of claim 10, wherein the second memory device is allocated to the BMC when the server system executes a basic input/output system (BIOS).

12. The electronic apparatus of claim 11, wherein the BMC is coupled to a memory access control pin of the basic input/output system (BIOS).

13. The electronic apparatus of claim 10, wherein the second memory device is allocated to the BMC when a memory sharing driver is installed to an operating system in the server system.

14. The electronic apparatus of claim 10, wherein the second memory device is a portion of a system memory in the server system.

15. The electronic apparatus of claim 14, wherein the server system further comprising:
a bridge coupled to the IPMI system; and
an input/output controller coupled between the bridge and the BMC, such that the BMC accesses the second memory device by communicating with the bridge.

16. The electronic apparatus of claim 15, wherein the bridge comprises a north bridge chip.

17. The electronic apparatus of claim 15, wherein the second memory device is a removable storage.

18. The electronic apparatus of claim 15, wherein the BMC further comprises a first interface coupled to the input/output controller.

19. The electronic apparatus of claim 18, wherein the first interface is a low pin count (LPC) interface.

20. The electronic apparatus of claim 10, wherein the BMC stops providing a second set of functions when the BMC cannot access the second memory device.

21. A memory sharing method, comprising:
connecting an IPMI system comprising a baseboard management controller (BMC) and a first memory device to a server system; and
allocating a second memory device to the IPMI system, such that the BMC accesses the first memory device to provide a first set of functions and accesses the second memory device from the server system to provide a second set of functions.

22. The memory sharing method of claim 21, wherein the second memory device is a portion of a system memory in the server system.

23. The memory sharing method of claim 21, wherein the second memory device is allocated to IPMI system when a memory sharing driver is installed to an operating system in the server system.

24. The memory sharing method of claim 23, wherein the BMC accesses the second memory device by communicating with a bridge in the server system.

25. The memory sharing method of claim 24, wherein the second memory device is a removable storage.

26. The memory sharing method of claim 23, wherein the step of allocating the second memory device to the IPMI system further comprises:
determining whether the memory sharing driver exists by the operating system in the server system; and
allocating the second memory device to the IPMI system when the memory sharing driver exists in the operating system.

27. The memory sharing method of claim 26, further comprising:
determining whether the second memory device is still accessible by the IPMI system; and
stopping providing the second set of functions by the IPMI system when the second memory device is not accessible by the IPMI system.

28. The memory sharing method of claim 21, wherein the second memory device is allocated to the IPMI system by executing a basic input/output system (BIOS) in the server system.

29. The memory sharing method of claim 28, wherein the step of allocating the second memory device to the IPMI system further comprises:
determining whether a memory sharing is supported by the basic input/output system (BIOS) in the server system; and
allocating the second memory device to the IPMI system when the memory sharing is supported by the basic input/output system (BIOS) in the server system.
